(19) United States
(12) Patent Application Publication
(10) Pub. No.: US 2014/0013015 A1
(43) Pub. Date: Jan. 9, 2014

(54) METHOD AND SYSTEM FOR TRANSFERRING DATA BETWEEN PORTABLE TERMINAL AND EXTERNAL DEVICE

(71) Applicant: Whie CHANG, Seongnam-si (KR)

(72) Inventor: Whie CHANG, Seongnam-si (KR)

(21) Appl. No.: 13/718,790

(22) Filed: Dec. 18, 2012

(30) Foreign Application Priority Data
Jul. 6, 2012 (KR) 10-2012-0073947

(51) Int. Cl. G06F 13/28

(52) U.S. Cl. CPC G06F 13/28
USPC 710/22

(57) ABSTRACT

A system and method for transmitting and receiving data between a portable terminal and an external device are provided. The system includes a portable terminal for creating a data list according to selection of a user and wirelessly transmitting the data list, and wirelessly transmitting relevant data when data corresponding to the data list is requested; and a wireless data relay device connected to a USB interface of the external device, for converting the data list wirelessly received from the portable terminal into a flash memory data list and transferring the flash memory data list to the external device, and requesting data corresponding to the data list from the portable terminal according to a request of the external device, converting wireless data received from the portable terminal into data of a flash memory data output format and transferring the converted data to the external device.

### BACKGROUND OF THE INVENTION

1. Field of the Invention

The present invention relates to a system and method for transmitting and receiving data between a portable terminal and an external device, and more specifically, to a system and method for transmitting and receiving data between a portable terminal and an external device, in which data of the portable terminal is provided to the external device using a wireless data relay device which is connected to a USB interface of the external device, and thus the data of the portable terminal can be easily provided to the external device that does not support a wireless communication function and a function for synchronizing the external device with the portable terminal without separately adding a function to the external device.

2. Background of the Related Art

With the advancement in large-scale data communication and data processing techniques, recently, portable terminals such as smart phones, tablets, PDAs and the like provide a variety of functions comparable to those of a desktop computer, such as communication functions, office automation functions and the like. Accordingly, it is possible to create, play back and edit multimedia data or create office documents and store and manage data of the documents regardless of time and space.

Although such portable terminals provide convenience in portability and mobility, there is a limit in enjoying multimedia or reading a document since the size of a screen or the volume of a speaker is restricted.

Therefore, a user copies data stored in a portable terminal into a PC through a wireless or wired means and immediately uses the data, or the user uses a portable storage medium such as a memory stick, a compact disk (CD) or the like. Recently, USB memory sticks increase to be used to store and use data since the USB memory sticks are convenient to use and carry and a variety of external devices provided with a USB port, such as a TV, an audio system and the like, may use the USB memory sticks by directly connecting the USB memory sticks to a USB port.

When a data stored in a portable terminal is transferred to a USB port of an external device according to a conventional technique, the portable terminal should be directly connected to the external device using a USB cable, or the data stored in the portable terminal is copied into a PC and stored in a memory stick or the like, and the memory stick is connected to a USB port of an electronic device. However, the method of using a cable is accompanied with restrictions and inconveniences of cables, and when the portable terminal is connected to the external device, all the data stored in the portable terminal are exposed to the connected external device (an electronic device or a computer).

Then, the method of using a memory stick is inconvenient in that a user should copy the information stored in the portable terminal to a computer and store the information in the memory stick.

### SUMMARY OF THE INVENTION

Therefore, the present invention has been made in view of the above problems, and it is an object of the present invention to provide a system and method for transmitting and receiving data between a portable terminal and an external device, in which data of the portable terminal is provided to the external device using a wireless data relay device which is connected to a USB interface of the external device, and thus the data of the portable terminal can be easily provided to the external device that does not support a wireless communication function and a function for synchronizing the external device with the portable terminal without separately adding a function to the external device.

To accomplish the above object, according to one aspect of the present invention, there is provided a system for transmitting and receiving data between a portable terminal and an external device, the system comprising: a portable terminal for creating a data list according to selection of a user and wirelessly transmitting the data list, and wirelessly transmitting relevant data when data corresponding to the data list is requested; and a wireless data relay device connected to a USB interface of the external device, for converting the data list wirelessly received from the portable terminal into a flash memory data list and transferring the flash memory data list to the external device, and requesting data corresponding to the data list from the portable terminal according to a request of the external device, converting wireless data received from the portable terminal into data of a flash memory data output format and transferring the converted data to the external device.

Here, the portable terminal and the wireless data relay device may transmit and receive data in a WiFi communication method.

In addition, the wireless data relay device may convert the wirelessly received data list into the flash memory data list having at least any one of file system formats including FAT (File Allocation Table), FAT16, FAT32 and NTFS file system) and provide the external device with the flash memory data list.

According to another aspect of the present invention, there is provided a wireless data relay device comprising: a wireless communication unit for wirelessly transmitting and receiving data to and from a portable terminal; a USE interface connected to a USB interface of an external device; a data conversion unit for converting wireless data received from the portable terminal into data of a flash memory data format; and a communication control unit for converting a data list wirelessly received from the portable terminal into a flash memory data list and transferring the flash memory data list to the external device through the USB interface, and requesting data corresponding to the data list from the portable terminal according to a request of the external, device, converting wireless data received from the portable terminal into data of a flash memory data output format and transferring the converted data to the external device.

Here, the wireless communication unit may transmit and receive data in a WiFi communication method.

In addition, when data is not received from the portable terminal, the communication control unit may output an ID and a password to the external device.

According to still another aspect of the present invention, there is provided a method of transmitting and receiving data between a portable terminal and an external device, the method comprising the steps of: (a) creating a data list according to selection of a user and transmitting the data list, by the portable terminal; (b) receiving and converting the data list into a flash memory data list, by a wireless data relay device; (c) transmitting the flash memory data list to the external device through a USB interface, by the wireless data relay device; and (d) converting data and relaying transmission and reception of the data between the external device and the Portable terminal, by the wireless data relay device.

Here, step (d) may include the step of transmitting and receiving data in a WiFi communication method by the portable terminal and the wireless data relay device.

In addition, step (b) may include the step of converting the wirelessly received data list into the flash memory data list, having at least any one of file system formats including FAT (File Allocation Table), FAT16, FAT32 and NTFS (NT file system).

According to still another aspect of the present invention, there is provided a method of controlling a wireless data relay device, the method comprising the steps of: (a) converting a data list wirelessly received from a portable terminal into a flash memory data list; (b) transferring the flash memory data list to an external device through a USB interface; (c) requesting data corresponding to the data list from the portable terminal according to a request of the external device; and (d) converting wireless data received from the portable terminal into data of a flash memory data output format and transferring the converted data to the external device.

Here, the method of controlling a wireless data relay device may further include the step of, before step (a), outputting an ID and a password to the connected external device when data is not received from the portable terminal for a predetermined time.

### BRIEF DESCRIPTION OF THE DRAWINGS

FIG. 1 is a view showing the configuration of a system for transmitting and receiving data between a portable terminal and an external device according to an embodiment of the present invention.

FIG. 2 is a control block diagram showing a portable terminal according to an embodiment of the present invention.

FIG. 3 is a control block diagram showing a wireless data relay device and an external device according to an embodiment of the present invention.

FIG. 4 is a flowchart illustrating a method of transmitting and receiving data between a portable terminal and an external device according to an embodiment of the present invention.

### DESCRIPTION OF SYMBOLS

100: External device

110: USB: host interface

120: Data processing unit

200: Portable terminal

210: Data transmission and reception unit

220: Data list edit unit

230: Control unit

240: Data storage unit

300: Wireless data relay device

310: Wireless communication unit

320: communication control unit

330: Data list storage unit

340: Data conversion unit

350; USD client interface

### DETAILED DESCRIPTION OP THE PREFERRED EMBODIMENT

The preferred embodiments of the invention will be hereafter described in detail, with reference to the accompanying drawings. Furthermore, in the drawings illustrating the embodiments of the present invention, elements having like functions will be denoted by like reference numerals and details thereon will not be repeated.

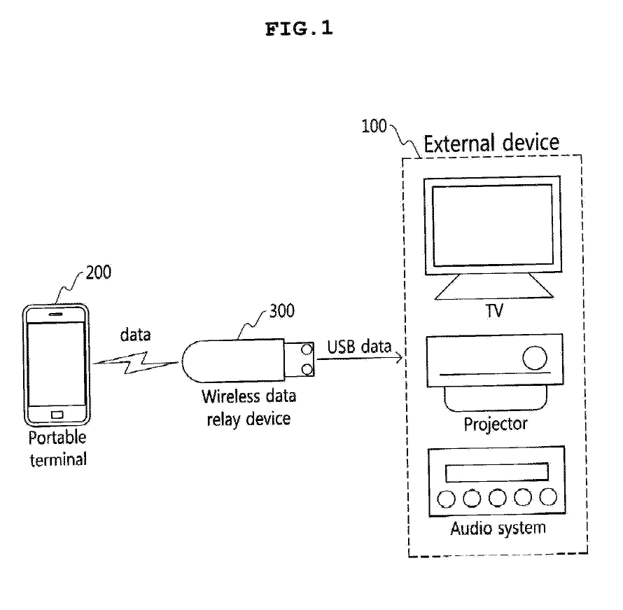

FIG. 1 is a view showing the configuration of a system for transmitting and receiving data between a portable terminal 200 and an external device 100 according to an embodiment of the present invention.

As shown in FIG. 1, the system of the present invention includes a portable terminal 200 for wirelessly transmitting stored data, a wireless data relay device 300 for converting the data wirelessly received from the portable terminal 200 into USB data and transmitting the USB data, and an external device 100 for processing and outputting the USB data received from the wireless data relay device 300.

The external device 100 is a device that can mount a USB memory and may include all kinds of devices having a data processing unit 120 and an input and output unit for processing and outputting data of the USB memory. For example, it includes all kinds of devices capable of reading and processing data Stored in the USB flash memory when the USB flash memory is connected, such as a TV, a projector, an audio system, a desktop computer, a navigator, a personal computer (PC) and the like having a USB port.

The portable terminal 200 creates a list of data to be transmitted by the selection of a user and wirelessly transmits the data list to the wireless data relay device 300. If the wireless data relay device 300 requests specific data, the portable terminal 200 wirelessly transmits corresponding data. Here, the portable terminal 200 may transmit the data to the wireless data relay device 300 in a WiFi communication method which supports wireless transmission of a large-scale data. Terminals capable of wirelessly transmitting data to the wireless data relay device 300, such as a smart phone, a tablet, a notebook computer and the like, can be applied as the portable terminal 200.

The wireless data relay device 300 converts the Wireless data received from the portable terminal 200 into data of a USB memory format and provides the external device 100 with the converted data. The wireless data relay device 300 is connected to a USB port of the external device 100 and recognized as a virtual USB memory by the external device 100, and the wireless data relay device 300 transmits and receives wireless data to and from the portable terminal 200 in a WiFi communication method. The wireless data relay device 300 receives the list of data to be transmitted from the portable terminal 200 and provides the data list to the external device 100. Then, the wireless data relay device 300 converts the data received from the portable terminal 200 into data of a USB memory output format and provides the external device 100 with the converted data Then, the external device 100 may recognize and process the data of the portable terminal 200 wirelessly received by the wireless data relay device 300 in a manner the same as that of processing data stored in a general USB memory.

According to the configuration described above, the system of the present invention is able to mount the wireless data relay device 300 onto a USB port of the external device 100 and transmit data stored in the portable terminal 200 to the wireless data relay device 300 using a wireless network such as WiFi.

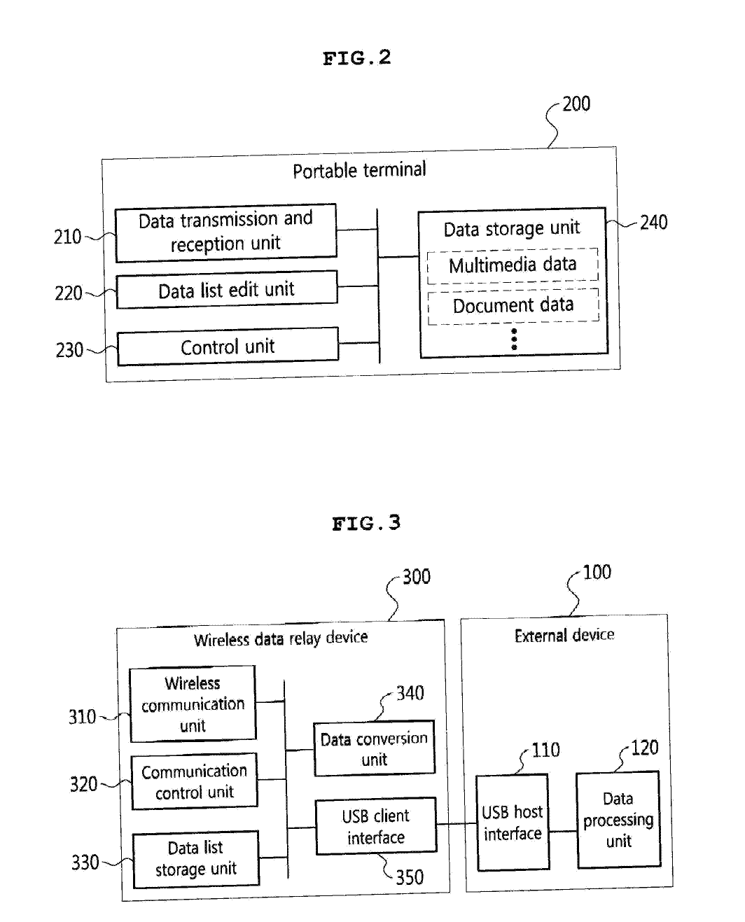

FIG. 2 is a control block diagram showing a portable terminal 200 according to an embodiment of the present invention.

As shown in FIG. 2, the portable terminal 200 includes a data transmission and reception unit 210, a data storage unit 240, a data list edit unit 220 and a control unit 230.

The data transmission and reception unit 210 transmits and receives data to and from the wireless data relay device 300. The data transmission and reception unit 210 may transmit and receive data to and from the wireless data relay device 300 in a previously determined wireless communication method, and particularly, it can transmit and receive data to and from the wireless data relay device 300 in a WiFi communication method that is advantageous in transmitting and receiving a large-scale data.

The data storage unit 240 may store various types of data such as multimedia data including music, pictures, moving images and the like and document data.

The data list edit unit 220 creates a list of data to be transmitted to the wireless data relay device 300 by the selection of a user. For example, the data list edit unit 220 may create a play list of music data or a play list of moving images selected by the user.

The control unit 230 transmits the data list created by the data list edit unit 220 to the wireless data relay device 300 through the data transmission and reception unit 210. The control unit 230 reads data requested by the wireless data relay device 300 from the data storage unit 240 and transmits the data to the wireless data relay device 300 through the data transmission and reception unit 210,

FIG. 3 is a control block diagram showing a wireless data relay device 300 and an external device 100 according to an embodiment of the present invention.

The wireless data relay device 300 and the external device 100 are connected through USB interfaces 110 and 350, and the external device 100 recognizes the wireless data relay device 300 as a virtual USB memory device.

Although a USB memory device may include a PC Card (PCMCIA), Compact Flash (CF), Smart Media (SM/SMC), Memory Stick (MS), Memory Stick Duo (MSD), Multimedia Card (MMC), Secure Digital card (SD), miniSD card, microSD card, xD-Picture Card and the like, in this description, the external device 100 recognizes and processes the wireless data relay device 300 as a virtual USB flash memory.

The USB host interface 110 of the external device 100 may input and output the data stored in the virtual USB flash memory by applying a file system such as FAT (File Allocation Table), FAT16, FAT32, NTFS (NT file system) or the like.

The data processing unit 120 of the external device 100 processes data inputted through the USB host interface 110. The data processing unit 120 may process and output multimedia data, document data and the like according to the type of the external device 100 For example, the data processing unit 120 may process images if the external device 100 is a TV and process document data, image data and the like if the external device 100 is a projector.

Meanwhile, the wireless data relay device 300 includes a wireless communication unit 310, a communication control unit 320, a data list storage unit 330, a data conversion unit 340, and a USB client interface 350.

The USB client interface 350 is connected to the USB host interface 110 of the external device 100 and transmits and receives data.

The wireless communication unit 310 transmits and receives data to and from the portable terminal 200. The wireless communication unit 310 may transmit and receive data to and from the portable terminal 200 in a previously determined wireless communication method, and particularly, it can transmit and receive data to and from the wireless data relay device 300 in a WiFi communication method that is advantageous in transmitting and receiving a large-scale data.

The data list storage unit 330 stores the data list received from the portable terminal 200.

The data conversion unit 340 converts the data list received from the portable terminal 200 into data of a file system applied to a flash memory, e.g., a FAT32 format, and provides the external device 100 with the converted data. Then, the external device 100 recognizes the wireless data relay device 300 as a virtual USB flash memory device storing data corresponding to the data list of the portable terminal 200.

After transferring the data list, the data conversion unit 340 converts the data wirelessly received from the portable terminal 200 into data of a flash memory format, i.e., a FAT32 format, and provides the external device 100 with the converted data through the USB client interface 350. Then, the external device 100 may receive and process the data provided by the wireless data relay device 300 in a manner the same as that of processing data provided by a general USB flash memory device.

The communication control unit 320 requests data from the portable terminal 200 through the wireless communication unit 310 based on the data list received through the wireless communication unit 310 and transfers data of the portable terminal 200 received through the wireless communication unit 310 to the data conversion unit 340. The communication control unit 320 may relay transmission and reception of data between the portable terminal 200 and the external device 100, and thus the data stored in the portable terminal 200 can be transferred to the external device 100 in real-time.

The communication control unit 320 may authenticate a user based on an ID and a password received from the portable terminal 200. The ID and the password can be set by the user himself or herself, or they can be set when the system is designed and provided to the user.

Meanwhile, it the wireless data relay device 300 is not connected to the portable terminal 200 while being connected to the external device 100, the communication unit 320 may display a previously stored ID and password on the external device 100. Accordingly, when the user forgets the ID and the password for connecting the portable terminal 200 and the wireless data relay device 300, the user may confirm the connection ID and the password by connecting the wireless data relay device 300 to the external device 100. Owing to such a configuration, the wireless data relay device 300 can be mounted on the external device 100 in a manner the same as that of the USB memory device, wirelessly receive data from the portable terminal 200 and transfer the data to the external device 100.

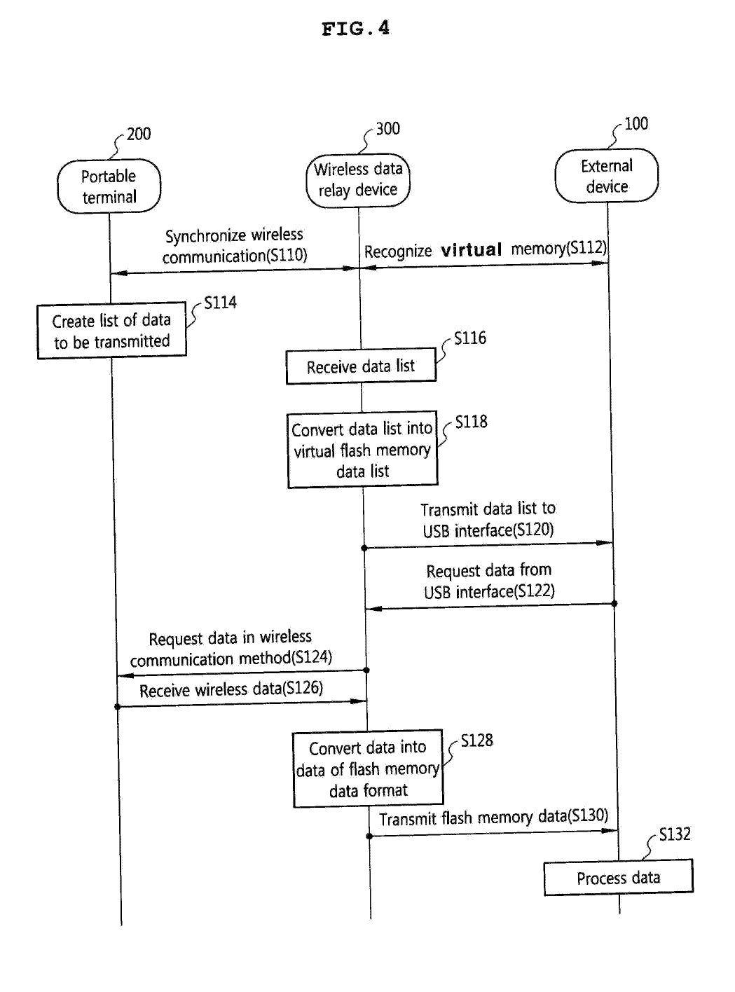

FIG. 4 is a flowchart illustrating a method of transmitting and receiving data between a portable terminal 200 and an external device 100 according to an embodiment of the present invention.

The portable terminal 200 synchronizes wireless communication with the wireless data relay device 300 S110, and the wireless data relay device 300 is mounted on the external device 100 in a manner the same as that of s USB memory device and recognized as a virtual USD memory by the external device 100 S112.

The portable terminal 200 creates a list of data to be transmitted by the selection of a user S114. The process of creating the data list can be performed before step S110 that is a process of synchronizing wireless communication.

The wireless data relay device 300 wirelessly receives the data list created by the portable terminal 200 S116 and converts information on the received data list into a flash memory data list S118. The received data list can be converted into a data list of a file system format applied to flash memory, e.g., a FAT32 format.

The wireless data relay device 300 transmits the virtual flash memory data list to the external device 100 through the USB interface S120. Then, the external device 100 recognizes the wireless data relay device 300 as a virtual flash memory in which data corresponding to the received flash memory data list is stored.

Then, the data processing device requests data from the wireless data relay device 300 through the USB interface S122, and the wireless data relay device 300 requests corresponding data from the portable terminal 200 in a wireless communication method S124.

The wireless data relay device 300 wirelessly receives the data from the portable terminal 200 S126 and converts the received data into data, of a flash memory format S120.

The wireless data relay device 300 provides the external device with the data in a manner the same as that of providing data of a flash memory S130.

Then, the external device 100 receives and processes the data received from the wireless data relay device 300 in a manner the same as that of processing data received from the USB memory S132.

As described above, the system and method for transmitting and receiving data between a portable terminal and an external device may provide data of the portable terminal to the external device using a wireless data relay device which is connected to a USB interface of the external device, and thus the data of the portable terminal can be easily provided to the external device that does not support a wireless communication function and a function for synchronizing the external device with the portable terminal without separately adding a function to the external device.

As described above, the present invention may provide a system and method for transmitting and receiving data between a portable terminal and an external device, which can easily provide data of the portable terminal to the external device that does not support a wireless communication function and a function for synchronizing the external device with the portable terminal without separately adding a function to the external device.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A system for transmitting and receiving data between a portable terminal and an external device, the system comprising:
a portable terminal for creating a data list according to selection of a user and wirelessly transmitting the data list, and wirelessly transmitting relevant data when data corresponding to the data list is requested; and
a wireless data relay device connected to a USB interface of the external device, for converting the data list wirelessly received from the portable terminal into a flash memory data list and transferring the flash memory data list to the external device, and requesting data corresponding to the data list from the portable terminal according to a request of the external device, converting wireless data received from the portable terminal into data of a flash memory data output format and transferring the converted data to the external device.

2. The system according to claim 1, wherein the portable terminal and the wireless data relay device transmit and receive data in a WiFi communication method.

3. The system according to claim 1, wherein the wireless data relay device converts the wirelessly received data list into the flash memory data list having at least any one of file system formats including FAT (File Allocation Table), FAT16, FAT32 and NTFS (NT file system) and provides the external device with the flash memory data list.

4. A wireless data relay device comprising:
a wireless communication unit for wirelessly transmitting and receiving data to and from a portable terminal;
a USB interface connected to a USB interface of an external device;
a data conversion unit for converting wireless data received from the portable terminal into data of a flash memory data format; and
a communication control unit for converting the data list wirelessly received from the portable terminal into a flash memory data list and transferring the flash memory data list to the external device through the USB interface, and requesting data corresponding to the data list from the portable terminal according to a request of the external device, converting wireless data received from the portable terminal into data of a flash memory data output format and transferring the converted data to the external device.

5. The apparatus according to claim 4, wherein the wireless communication unit transmits and receives data in a WiFi communication method.

6. The apparatus according to claim 4, wherein when data is not received from the portable terminal, the communication control unit outputs an ID and a password to the external device.

7. A method of transmitting and receiving data between a portable terminal and an external device, the method comprising the steps of:
(a) creating a data list according to selection of a user and transmitting the data list, by the portable terminal;
(b) receiving and converting the data list into a flash memory data list, by a wireless data relay device;
(c) transmitting the flash memory data list to the external device through a USB interface, by the wireless data relay device; and
(d) converting data and relaying transmission and reception of the data between the external device and the portable terminal, by the wireless data relay device.

8. The method according to claim 7, wherein step (d) includes the step of transmitting and receiving data in a WiFi communication method by the portable terminal and the wireless data relay device.

9. The method according to claim 7, wherein step (b) includes the step of converting the wirelessly received data list into the flash memory data list having at least any one of file system formats including FAT (File Allocation Table), FAT16, FAT32 and NTFS (NT file system).

10. A method of controlling a wireless data relay device, the method comprising the steps of:
(a) converting a data list wirelessly received from a portable terminal into a flash memory data list;
(b) transferring the flash memory data list to an external device through a USB interface;
(c) requesting data corresponding to the data list from the portable terminal according to a request of the external device; and
(d) converting wireless data received from the portable terminal into data of a flash memory data output format and transferring the converted data to the external device.

11. The method according to claim 10, further comprising the step of, before step (a), outputting an ID and a password to the connected external device when data is not received from the portable terminal.
